(19) United States
(12) Patent Application Publication
(10) Pub. No.: US 2003/0074711 A1
(43) Pub. Date: Apr. 24, 2003

(54) Pressure vest for treating autism

(76) Inventor: Portia E. Iversen, Los Angeles, CA (US)

Correspondence Address: Eric L. Tanezaki, STETINA BRUNDA GARRED & BRUCKER, Suite 250, 75 Enterprise, Aliso Viejo, CA, 92656, US

(21) Appl. No.: 10/273,035

(22) Filed: Oct. 17, 2002

Related U.S. Application Data
(60) Provisional application No. 60/334,635, filed on Oct. 19, 2001.

(51) Int. Cl. A41D 1/04; G09B 19/00

(52) U.S. Cl. 2/69; 434/236

(57) ABSTRACT

There is provided a pressure vest for applying pressure upon a torso of a wearer. The pressure vest comprises a torso-engaging member configured to engage the torso of the wearer. Moreover, a plurality of pressure applicators are disposed about the torso-engaging member. Further, at least one sensor for detecting moisture of the wearer is in communication with each of the pressure applicators. The sensor activates the pressure applicators in response to detected moisture for applying pressure upon the torso of the wearer.

### CROSS-REFERENCE TO RELATED APPLICATIONS

This application claims the benefit of U.S. Provisional Application No. 60/334,635 entitled “METHOD FOR AUTISM TREATMENT UTILIZING PRESSURE VEST RESPONSIVE TO GALVANIC SKIN RESPONSE” filed Oct. 19, 2001, the entirety of the disclosure of which is expressly incorporated herein by reference.

### STATEMENT RE: FEDERALLY SPONSORED RESEARCH/DEVELOPMENT

(Not Applicable)

### BACKGROUND OF THE INVENTION

The present invention relates generally to autism treating devices, and more particularly to an improved autism treating device utilizing a pressure vest for applying pressure upon a wearer's torso so as to modulate the abnormal arousal state suffered by its wearer.

Generally, autism is a neurological disorder that affects the normal functioning of the brain. It creates abnormal development in communication and social skills, as well as the ability to reason. In this regard, typical symptoms of autism comprise inability to communicate normally, resistance to changes in daily routine, impairment in social interaction, and fixation on inanimate objects.

However, behaviors of autistic sufferers may change with proper training and teaching. Specifically, it has been found that autistic sufferers may be trained and taught over time to dampen the symptoms associated with autism. With patient supervision, autistic sufferers may overcome such symptoms and enjoy normal lives to the greatest extent possible.

As such, proper training and teaching are essential in mitigating symptoms associated with autism. It is important that autistic sufferers are fully attentive to the training and teaching provided to them. However, autistic sufferers frequently suffer abnormal arousal patterns in their behaviors which are tremendously interruptive and unproductive to their learning. Specifically, they enter into over aroused and/or under aroused states that are almost cationic in nature, and thus make it difficult to get through to them. Put simply, neither states are conducive to learning and memory, or social interaction.

Massaging or squeezing has proven to mitigate the abnormal arousal patterns of the autistic sufferers because it is believed to help regulate their autonomic systems. However, although the means of reducing the abnormal arousal patterns are known, it is oftentimes inconvenient and arduous to carry them out. Massaging or squeezing the autistic sufferer every time he/she is over or under aroused may become a significant task that may be hard to bear. This may even be impossible when multiple numbers of autistic sufferers simultaneously portray these patterns, such as in middle of their lessons for example.

Thus, there exists a need for a device which can maintain an autistic sufferer in a normal range of autonomic activity without resorting to human massaging or squeezing. Further, there exists a need for a device which can immediately detect an abnormal arousal pattern so that such pattern may be addressed and regulated upon its occurrence.

### BRIEF SUMMARY OF THE INVENTION

In accordance with the present invention, there is provided a pressure vest for applying pressure upon a torso of a wearer. The pressure vest comprises a torso-engaging member configured to engage the torso of the wearer. Moreover, a plurality of pressure applicators are disposed about the torso-engaging member. Further, at least one sensor for detecting moisture of the wearer is in communication with each of the pressure applicators. The sensor activates the pressure applicators in response to detected moisture for applying the pressure upon the torso of the wearer.

More specifically, the torso-engaging member has an interior surface. The pressure applicators may be engaged to the interior surface. The pressure applicators are preferably polymers, and even more preferably, polymer gels. As such, the pressure applicators may be inflated upon activation.

The present pressure vest further comprises a galvanic skin response (GSR) measuring device which may be placed in communication between the sensor and the pressure applicators. The GSR measuring device may be operative to receive and measure the detected moisture from the sensor and selectively activate the pressure applicators in response thereto. In addition, the GSR measuring device may be disposed about the torso-engaging member.

In the present invention, the sensor and the GSR measuring device may electrically communicate with each other via a sensor-to-GSR wire. This wire may have at least one attachment band which is configured to secure the sensor-to-GSR wire along an arm of the wearer. Furthermore, the GSR measuring device may electrically communicate with each of the pressure applicators via GSR-to-applicator wires.

The sensor may be configured to detect an electrical charge of moisture associated with a hand of the wearer. The sensor may generate and transmit a sensor signal corresponding to detected electrical charge to the GSR measuring device. Moreover, the GSR measuring device may further comprise a converter for converting the sensor signal into a GSR signal depending upon an intensity of the detected electrical charge.

Specifically, the sensor signal may be converted into the GSR signal when the detected electrical charge reaches a threshold intensity. The GSR measuring device may then transmit the GSR signal to activate the pressure applicators.

### BRIEF DESCRIPTION OF THE DRAWINGS

These as well as other features of the present invention will become more apparent upon reference to the drawings wherein:

FIG. 1 is a perspective view of a pressure vest constructed in accordance with a preferred embodiment of the present invention.

### DETAILED DESCRIPTION OF THE INVENTION

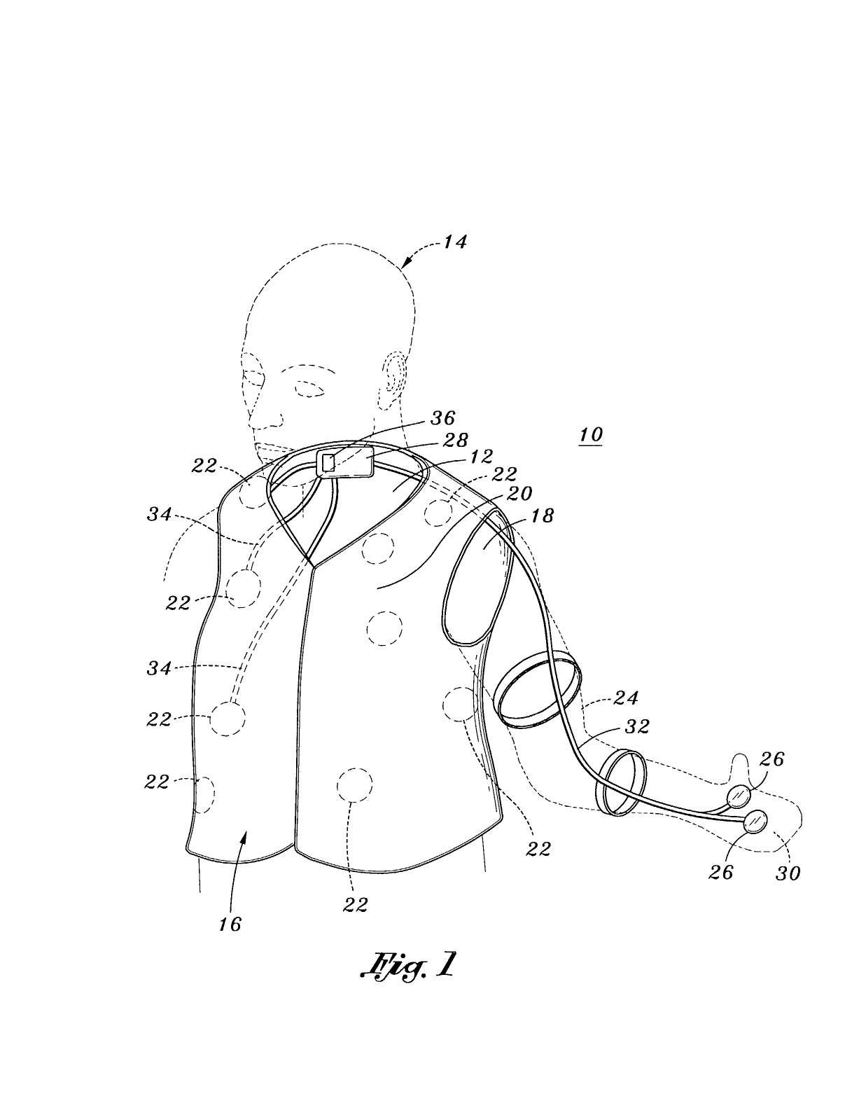

Referring now to the drawings wherein the showings are for purposes of illustrating preferred embodiments of the present invention only, and not for purposes of limiting the same, FIG. 1 perspectively illustrates a pressure vest 10 constructed in accordance with a preferred embodiment of the present invention. The pressure vest 10 is adapted to selectively apply pressure upon a torso 12 of its wearer 14 (e.g., autistic sufferer) for the purpose of regulating his/her autonomic activity. As such, by addressing and regulating the autonomic activity when an abnormal arousal pattern is detected, the pressure vest 10 allows its wearer to focus on activities such as learning without distractions caused thereby.

The pressure vest 10 as shown in FIG. 1 comprises a torso-engaging member 16 which is configured to engage the torso 12 of its wearer 14. The torso-engaging member 16 defines an interior surface 18 and an exterior surface 20. Disposed about the interior surface 18 and further engaged thereto are a plurality of pressure applicators 22. The pressure applicators 22 are engaged to the interior surface 18 in a spaced apart relation from each other.

More specifically, the pressure applicators 22 are small pockets of polymer. Even more specifically, they are polymer gels. These polymers are adapted to exhibit abrupt volume changes in response to variations in their external conditions, even shrinking or swelling up to 1000 times their original volume. Simply put, the polymer gels may rapidly change from liquid to solid upon charge change to cause pressure to be applied to the wearer's torso 12. Such application may further be extended to an arm 24, leg or any other body are of the wearer 14.

The torso-engaging member 16 also comprises at least one sensor 26 for detecting moisture of the wearer 14. The sensor 26 is placed in communication with each of the pressure applicators 22 for the purpose of activating the same. It activates the pressure applicators 22 in response to detected moisture from the wearer 14 so as to apply the pressure upon the wearer's torso 12 therewith. As illustrated in FIG. 1, two sensors 26 may be used for the intended purpose of detecting moisture. However, it will be recognized by those of ordinary skill in the art that one or more than two sensors 26 may be used to serve such purpose.

In particular, the measuring of moisture such as sweat across a palm of the wearer's hand 30 (via eccrine sweat glands), preferably the non-dominant hand 30, may provide an indication of abnormal arousal pattern. Specifically, it may serve as a stimulation indicia of the sympathetic (“fight or flight”) branch of the autonomic nervous system. In this regard, by placing the sensor 26 upon the non-dominant hand 30 of the wearer 14 to detect an electrical charge of the moisture conducted thereacross, an indication of abnormal arousal pattern may be observed.

The sensor 26 and the pressure applicators 22 communicate with each other through a galvanic skin response (GSR) measuring device 28. The GSR measuring device 28 may be disposed about the torso-engaging member 16, either on the interior or exterior surface 18, 20 thereof. The sensor 26 is in electrical communication with the GSR measuring device 28 via a sensor-to-GSR wire 32. This wire 32 has at least one attachment band 34 which can be used to secure the wire 32 along an arm 24 of the wearer 14 (as shown in FIG. 1). Further, the GSR measuring device 28 electrically communicates with each of the pressure applicators 22 via a number of GSR-to-applicator wires 34. The GSR-to-applicator wires 34 may extend along the interior surface 18 of the torso-engaging member 16.

Primarily, the GSR measuring device 28 is operative to receive and measure the detected moisture from the sensor to selectively activate the pressure applicators 22 in response thereto. More specifically, the sensor 26 may generate a sensor signal which corresponds to the electrical charge detected at the non-dominant hand 30 of the wearer 14. As such, data regarding abnormal arousal patterns via the detected electrical charge of moisture is transmitted to the GSR measuring device 28 in the form of the sensor signal.

The GSR measuring device 28 comprises a converter 36 for converting the sensor signal into a GSR signal. This conversion depends upon an intensity of the detected electrical charge at the wearer's hand 30. In particular, the sensor signal may be converted when the detected electrical charge reaches a threshold intensity. More particularly, the sensor signal may be converted by the converter 36 when the electrical charge associated therewith reaches the maximum “normal” peak level. The conversion would cease when it plummets below that level towards the minimal “normal” level.

The GSR measuring device 28 may operate to transmit the GSR signal to the pressure applicators 22. Upon receiving the GSR signal, the pressure applicators 22 may be activated (via changing from liquid to solid) so as to apply gentle pressure upon the wearer's torso 12. By quickly inflating to this state, the pressure applicators 22 simulate massaging and/or squeezing as it would be performed by an another person. In this respect, the pressure vest 10 mechanically regulates the arousal pattern of its wearer in order to keep him/her within the normal range of arousal level, thus increasing the wearer's ability to stay calm, to focus and to learn.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. A pressure vest for applying pressure upon a torso of a wearer, the pressure vest comprising:
a torso-engaging member configured to engage the torso of the wearer;
a plurality of pressure applicators disposed about the torso-engaging member; and
at least one sensor for detecting moisture of the wearer in communication with each of the pressure applicators, the sensor activating the pressure applicators in response to detected moisture for applying pressure upon the torso of the wearer.

2. The pressure vest of claim 1 wherein the torso-engaging member has an interior surface, the pressure applicators being engaged to the interior surface.

3. The pressure vest of claim 1 wherein the pressure applicators are polymers.

4. The pressure vest of claim 3 wherein the polymers are polymer gels.

5. The pressure vest of claim 1 further comprising a galvanic skin response (GSR) measuring device placed in communication between the sensor and the pressure applicators, the GSR measuring device being operative to receive and measure the detected moisture from the sensor and selectively activate the pressure applicators in response thereto.

6. The pressure vest of claim 5 wherein the GSR measuring device is disposed about the torso-engaging member.

7. The pressure vest of claim 5 wherein the sensor and the GSR measuring device electrically communicate with each other via a sensor-to-GSR wire having at least one attachment band, the at least one attachment band being configured to secure the sensor-to-GSR wire along an arm of the wearer.

8. The pressure vest of claim 5 wherein the GSR measuring device electrically communicates with each of the pressure applicators via GSR-to-applicator wires.

9. The pressure vest of claim 5 wherein the sensor is configured to detect an electrical charge of moisture associated with a hand of the wearer, the sensor generating and transmitting a sensor signal corresponding to detected electrical charge to the GSR measuring device.

10. The pressure vest of claim 9 wherein the GSR measuring device comprises a converter for converting the sensor signal into a GSR signal depending upon an intensity of the detected electrical charge.

11. The pressure vest of claim 10 wherein the sensor signal is converted into the GSR signal when the detected electrical charge reaches a threshold intensity.

12. The pressure vest of claim 10 wherein the GSR measuring device transmits the GSR signal to activate the pressure applicators.

13. The pressure vest of claim 1 wherein the pressure applicators are inflated upon activation.

14. A method of applying pressure upon a torso of a wearer, the method comprising the steps of:
a) engaging a pressure vest around the torso of the wearer;
b) placing at least one sensor of the pressure vest on a hand of the wearer;
c) detecting moisture produced at the hand with the sensor;
d) activating a plurality of pressure applicators disposed about the pressure vest in response to detected moisture; and
e) applying pressure upon the torso of the wearer with the activated pressure applicators.

15. The method of claim 14 wherein steps c) and d) comprise:
1) detecting an electrical charge of moisture with the sensor;
2) generating a sensor signal corresponding to detected electrical charge;
3) defining a galvanic skin response (GSR) measuring device of the pressure vest;
4) transmitting the sensor signal to the GSR measuring device; and
5) activating the pressure applicators with the GSR measuring device.

16. The method of claim 15 wherein step 5) comprises:
i) defining a converter of the GSR measuring device;
ii) converting the sensor signal into a GSR signal when the detected electrical charge reaches a threshold intensity; and
iii) transmitting the GSR signal to the pressure applicators.

17. The method of claim 14 wherein the pressure applicators in step d) are polymer gels.

18. The method of claim 14 wherein step e) comprises inflating the pressure applicators upon activation.
